(19) United States
(12) Patent Application Publication
(10) Pub. No.: US 2003/0092415 A1
(43) Pub. Date: May 15, 2003

(54) Antenna for portable radio telephone

(75) Inventors: Jae-Sun Park, Suwon-shi (KR); Chae-Sung Jung, Suwon-shi (KR); Dong-Kyu Lee, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/291,144

(22) Filed: Nov. 8, 2002

(30) Foreign Application Priority Data
Nov. 13, 2001 (KR) P2001-70575

(51) Int. Cl. H04B 1/06; H04B 7/00

(52) U.S. Cl. 455/277.1; 455/274

(57) ABSTRACT

The invention relates to an antenna structure for a portable radio telephone comprising a helical antenna and a rod antenna. The helical antenna is inserted into the portable radio telephone, and the rod antenna is concealed when it is retracted into the telephone. The helical antenna is electrically connected to a Radio Frequency (RF) terminal in the telephone and the rod antenna is electrically connected to a ground terminal in a Printed Circuit Board (PCB) of the telephone to have a dipole structure.

### PRIORITY

This application claims priority to an application entitled “Antenna for Portable Radiotelephone” filed in the Korean Intellectual Property Office on Nov. 13, 2001 and assigned Serial No. 2001-70575, the contents of which are hereby incorporated by reference.

### BACKGROUND OF THE INVENTION

1. Field of the Invention

The present invention relates to an antenna for a portable radio telephone, and more particularly, to an antenna structure having a rod antenna and a helical antenna operating in a dipole array.

2. Description of the Related Art

Radio telephones generally adopt only an extensible/retractable rod antenna that retracts into a body of the radio telephone. When retracted, the rod antenna has the disadvantage of being closely positioned to the radio telephone body and the radio telephone Printed Circuit Board (PCB) assembly, which causes radio interference. Further, the effective opening area in which to position the rod antenna is reduced by the position of the radio telephone speaker, which typically contacts the user's ear. These factors also cause the antenna impedance to vary, which can sharply drop the effective gain of the antenna.

In an attempt to overcome such shortcomings, radio telephones of the related art position the rod antenna is inserted into the upper end of the telephone, together with a helical antenna mounted on the outside of the radio telephone housing via insert molding. When the rod antenna is completely extended, a Radio Frequency (RF) section of the PCB is electrically connected to the helical and rod antennas to construct a complex antenna in order to further elevate the transmitting/receiving sensitivity of the radio telephone.

FIG. 1 is a perspective view illustrating a general portable radio telephone, in which a body 100 comprises an upper housing frame 111 and a lower housing frame 112. The body 100 is provided in the upper end with an antenna structure 160. Below the antenna structure 160 are provided an speaker 120, a display unit 130, a keypad unit (not shown) and a microphone unit 150. In addition, the body 100 can be provided with a flip cover 140 for protecting the keypad unit, as well as housing an antenna and/or another microphone (not shown).

FIG. 2 is a partial sectional view illustrating an antenna structure of the related art in which a rod antenna is retracted into a helical antenna, and FIG. 3 is a partial sectional view illustrating the antenna structure of the related art in which the rod antenna is completely extended from the helical antenna.

As shown in FIGS. 2 and 3, the antenna structure 160 typically comprises of a helical antenna 161 installed on the lower housing frame 112 of the body 100 and a rod antenna 165 capable of vertically extending/retracting by penetrating the helical antenna 161.

The helical antenna 161 on the lower housing frame 112 mounts a helical core (not shown) within a housing thereof via an insert molding and so on. Although the helical coil substantially operates as the helical antenna, the core and the housing, within which the core is mounted, are hereinafter collectively referred to as the helical antenna in this application.

A metallic screw section 162 in the lower end of the helical antenna 161 is electrically connected to the core of the helical antenna 161, and at the same time, inserted into a metallic bushing 170 which is electrically connected to a Radio Frequency (RF) section 180 of a PCB of the telephone body.

In the meantime, a metallic stopper 166 is installed on the lower end of the rod antenna 165. The metallic stopper 166 moves with the rod antenna 165 when the rod antenna 165 extends/retracts from/into the helical antenna. 161.

When the rod antenna 165 is completely extended from the telephone, as shown in FIG. 3, the metallic stopper 166 contacts and forms an electrical connection with to the metallic screw 162 of the helical antenna 161 and also prevents the rod antenna 165 from completely separating from the helical antenna 161.

Further, the rod antenna 165 has an internal metallic core, which connects the metallic stopper 166 to a knob 167 at the top of the rod antenna 165.

Therefore, when the rod antenna 165 is completely extended on the helical antenna 161, the helical antenna 161 is electrically connected to the rod antenna 165.

According to technical features of the extensible antenna structure, when the rod antenna is retracted into the helical antenna, only the helical antenna operates since the rod antenna is no longer electrically connected to the RF section of the PCB. When the rod antenna is completely extended from the helical antenna, the rod antenna functions as a main antenna, rather than the helical antenna, determining transmitting/receiving characteristics of the antenna structure.

However, the helical antenna of the extensible antenna structure having the above construction outwardly projects from the telephone, making it inconvenient to carry the telephone. When the telephone is dropped on the ground, the outwardly projecting portion of the helical antenna is readily damaged. Further, the rod antenna and the helical antenna are constructed to overlap each other, which generates a mutual interference, thereby degrading the performance of the antenna structure.

### SUMMARY OF THE INVENTION

Accordingly, the present invention has been made to solve the foregoing problems and it is an object of the present invention to provide an antenna structure for a portable radio telephone having a construction in which a helical antenna does not project outside the telephone, reducing the size of the telephone.

Another object of the invention to provide a portable radio telephone having an antenna structure in which an antenna does not project outside the telephone in order to have convenient portability.

A further object of the invention to provide an antenna structure for a portable radio telephone which is so constructed to prevent an antenna from being easily damaged when the portable radio telephone is dropped.

A still further object of the invention is to provide an antenna structure for a portable radio telephone which is so constructed to prevent mutual interference when a helical antenna is connected to a rod antenna.

According to an aspect of the invention to obtain the above objects, it is provided an antenna structure for a portable radio telephone, comprising: a helical antenna and a rod antenna, wherein the helical antenna is inserted into the portable radio telephone, and the rod antenna is concealed when it is retracted into the telephone.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a general radio telephone;

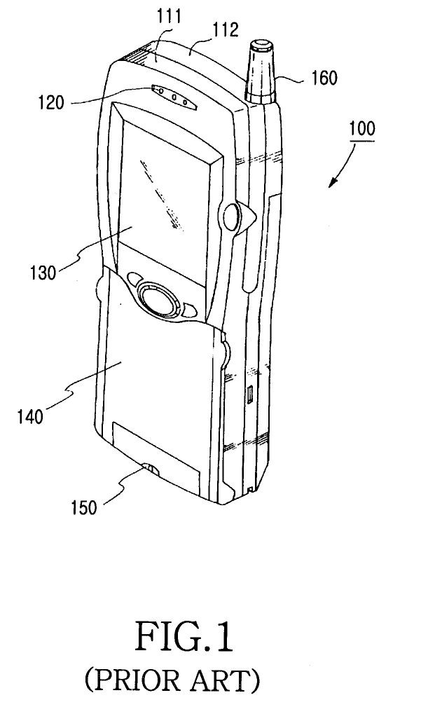

FIG. 2 is a partial sectional view illustrating an antenna structure of the related art in which a rod antenna is retracted into a helical antenna;

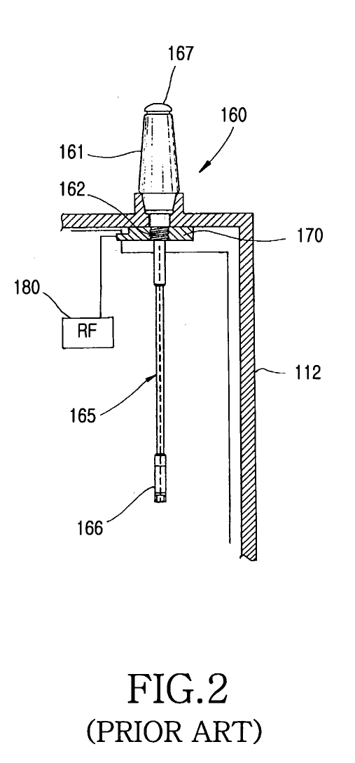

FIG. 3 is a partial sectional view illustrating the antenna structure of the related art in which the rod antenna is completely extended from the helical antenna;

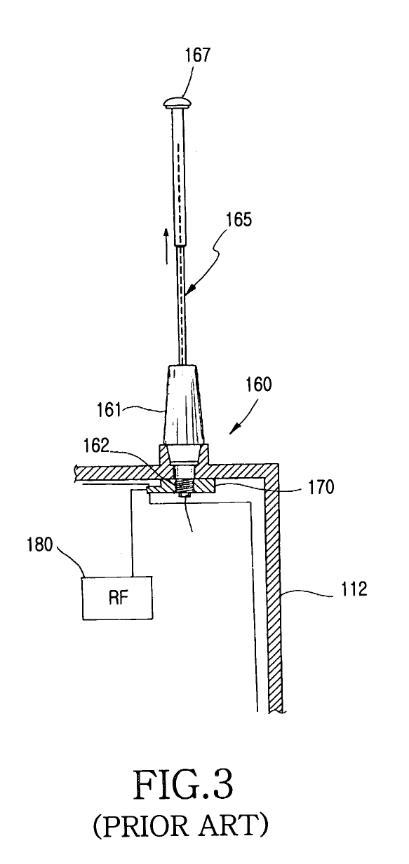

FIG. 4 is a perspective view illustrating a portable radio telephone having an antenna structure according to a preferred embodiment of the invention;

FIG. 5 is a partial sectional view illustrating an antenna structure according to a preferred embodiment of the invention in which a rod antenna is retracted into a helical antenna;

FIG. 6 is a partial sectional view illustrating the antenna structure according to a preferred embodiment of the invention in which the rod antenna is completely extended from the helical antenna; and

FIG. 7 illustrates a chip-type antenna applied to a telephone according to an alternative embodiment of the invention.

### DETAILED DESCRIPTION OF THE PREFERRED EMBODIMENTS

The following detailed description of the preferred embodiments of the invention references the accompanying drawings, in which well-known functions or constructions are not described in detail to avoid unnecessarily obscuring the understanding of the invention.

An antenna structure of the invention comprises a helical antenna installed in a radio telephone and a rod antenna operating separately from the helical antenna when not extended. In other words, the helical antenna is electrically connected to an RF terminal in the telephone, and the rod antenna is electrically connected to a ground terminal in a PCB of the telephone to prevent the overlapped connection between conventional helical and rod antennas thereby improving antenna performance. Therefore, the helical and rod antennas have a dipole structure.

Further, the helical antenna is mounted within the telephone while the rod antenna is concealed when it is completely retracted into the telephone, improving the portability of the telephone.

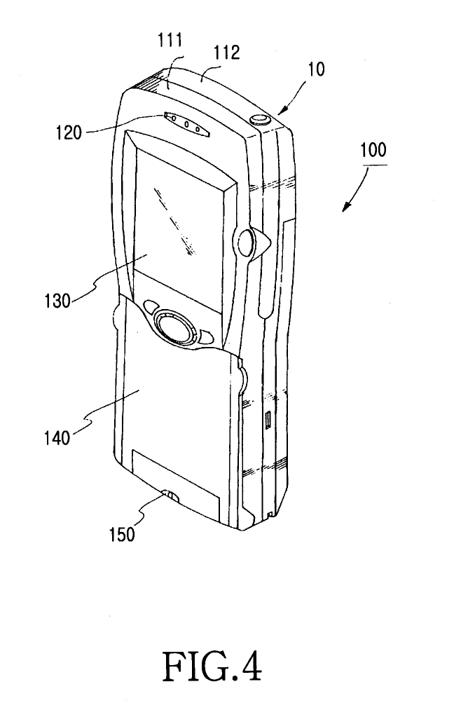

FIG. 4 is a perspective view illustrating a portable radio telephone having an antenna structure according to a preferred embodiment of the invention. The antenna structure 10 for transmitting/receiving signals is installed in an upper portion of a telephone body 100 constituted of upper and lower housing frames 111 and 112, respectively. Below the antenna structure 10 is installed a display unit 130 for displaying various transmitting/received data. The display unit 130 can utilize an LCD module, a touch screen with a touch pad and so on. Below the display unit 130, is installed a keypad unit (not shown) having a number of keys for entering data. In an upper portion of the upper housing frame 111 of the telephone is provided a speaker unit 120. In a lower portion of the telephone 100, is provided a microphone 150.

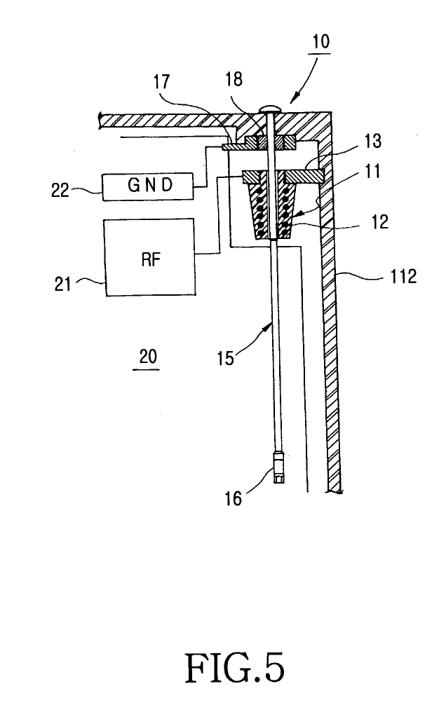

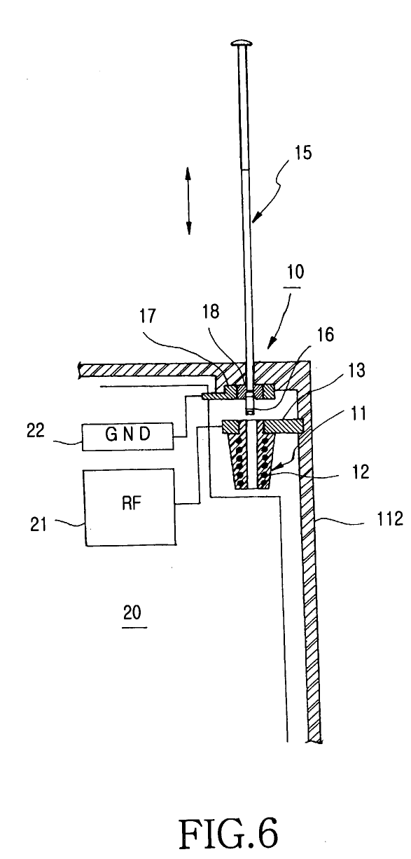

FIG. 5 is a partial sectional view illustrating an antenna structure according to a preferred embodiment of the invention in which a rod antenna is retracted into a helical antenna, and FIG. 6 is a partial sectional view illustrating the antenna structure according to a preferred embodiment of the invention in which the rod antenna is completely extended from the helical antenna. The antenna structure 10 of the invention comprises the helical antenna 11 and the rod antenna 15.

The helical antenna 11 installed in the lower housing frame 112 includes a helical core 12 that is mounted within the body of the radio telephone. Although the core 12 substantially functions as the helical antenna 11, both of the core and a housing within which the core is mounted are collectively referred to as the helical antenna.

The helical antenna 11 is installed and located within the radio telephone with an end thereof being inserted into a first metallic bushing 13, which is electrically connected to a Radio Frequency (RF) section of the radio telephone. The first metallic bushing 13 is preferably fixedly mounted in the housing frame is 112 of the telephone.

Further, the rod antenna 15 is capable of extending/retracting from/into the telephone in a vertical direction (indicated by an arrow in FIG. 6) through a hollow formed in the core of the helical antenna 11. Also within the body 100 of the telephone is installed a second metallic bushing 17. Inside the second metallic bushing 17, is installed a connector piece 18 for connecting to a metallic stopper 16 to the lower end of the rod antenna 15. The second metallic bushing 17 is electrically connected to a ground terminal 22 of a Printed Circuit Board (PCB) 20 of the telephone body 100. As a result, when the rod antenna 15 is completely extended from the telephone, the metallic stopper 16 of the rod antenna 15 is fixedly connected to the connector piece 18. This electrically connects the metallic stopper 16 to the ground terminal 22 of the PCB 20 so that the rod antenna 15 can function as an antenna.

Further, although the rod antenna 15 extends through the inside (i.e. the hollow) of the helical antenna 11, the rod antenna 15 is constructed to extend/retract outside the helical antenna.

As shown in FIG. 5, when the rod antenna 15 completely retracts into the telephone, only the helical antenna 11 connected to an RF terminal 21 of the telephone operates. In contrast, as shown in FIG. 6, the metallic stopper 16 installed in the end of the rod antenna 15, which contacts the ground terminal 22 via the connector piece 18 and the second metallic bushing 17 when the rod antenna 15 is completely extended from the telephone, allows the rod antenna 15 to function and operate as the antenna for the radio telephone, along with the helical antenna 11.

In other words, when the rod antenna 15 is completely extended from the telephone, the rod antenna 15 is separately connected to the ground terminal 22 of the PCB 20 while the helical antenna 11 is separately connected to the RF terminal 21, forming a dipole antenna structure.

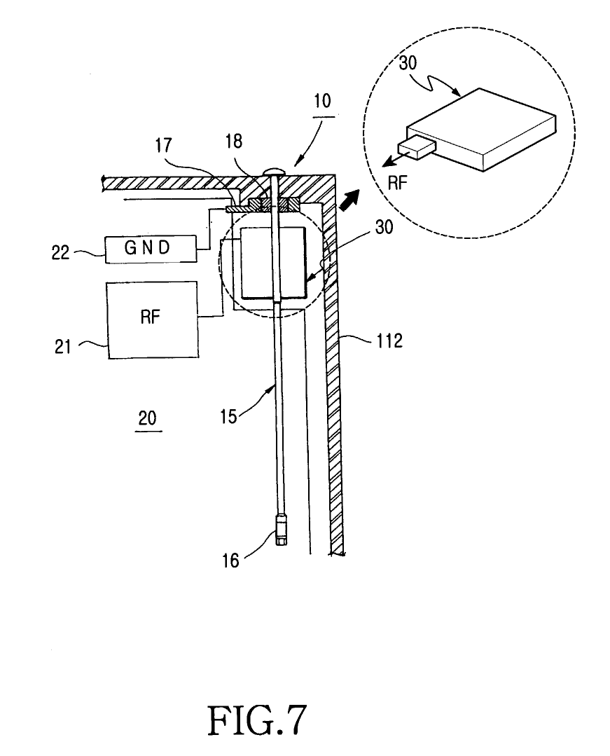

FIG. 7 illustrates a chip-type antenna applied to a telephone according to an alternative embodiment of the invention, in which a chip-mounted antenna 30 can be installed instead of the helical antenna within the telephone. The chip-type on-board antenna 30 can be positioned on a PCB 20 or elsewhere within the body 100 of the telephone to connect RF terminal 21.

Although the preferred embodiments of the present invention have been disclosed for illustrative purposes, those skilled in the art will appreciate that various modifications, additions and substitutions can be made without departing from the scope and spirit of the invention, as disclosed in the accompanying claims. For example, though the flip-type telephone is illustrated and described in the invention, it is apparent that the antenna structure of the invention can be applied to a folder-type, flip-up-type and bar type terminals as well.

In the antenna structure according to the embodiments of the invention as set forth above, the helical antenna is mounted within the terminal so as to improve the portability of the radio telephone as well as prevent the damage of the antenna. Further, the rod antenna and the helical antenna have separate electrical connections, thereby having the effect of preventing the deterioration of the antenna performance due to overlap.

What is claimed is:

1. An antenna structure for a portable radio telephone comprising:
a first antenna inserted into the telephone; and
a second antenna being extensible into/from the telephone,
wherein the second antenna is concealed when retracted into the telephone.

2. The antenna structure for a portable radio telephone according to claim 1, wherein the first antenna is a helical antenna, and the second antenna is a rod antenna.

3. An antenna structure for a portable radio telephone comprising:
a rod antenna; and
a helical antenna, wherein the helical antenna is electrically connected to a Radio Frequency (RF) terminal in the telephone and the rod antenna is electrically connected to a ground terminal of a Printed Circuit Board (PCB) in the telephone to form a dipole structure when the rod antenna is fully extended.

4. The antenna structure for a portable radio telephone according to claim 3, wherein the helical antenna is located within the telephone.

5. The antenna structure for a portable radio telephone according to claim 2, wherein the helical antenna includes a core having a center hollow; and
the rod antenna penetrates the center hollow.

6. The antenna structure for a portable radio telephone according to claim 1, wherein the first antenna is a chip-type antenna, and the second antenna is a rod antenna being extensible from and retractable into the telephone.

7. The antenna structure for a portable radio telephone according to claim 6, wherein the chip-type antenna is located within the telephone.

8. The antenna structure for a portable radio telephone according to claim 6,
wherein the first antenna is a PCB that is located within the telephone.
